(19) United States
(12) Patent Application Publication
(10) Pub. No.: US 2017/0371138 A1
(43) Pub. Date: Dec. 28, 2017

(54) MICROSCOPE AND MICROSCOPE-IMAGE ACQUISITION METHOD

(71) Applicant: OLYMPUS CORPORATION, Tokyo (JP)

(72) Inventor: Go RYU, Tokyo (JP)

(73) Assignee: OLYMPUS CORPORATION, Tokyo (JP)

(21) Appl. No.: 15/622,072

(22) Filed: Jun. 13, 2017

(30) Foreign Application Priority Data
Jun. 23, 2016 (JP) 2016-124535

(51) Int. Cl. G02B 21/00; G02B 21/36; G02B 21/08

(52) U.S. Cl. CPC G02B 21/0076; G02B 21/082; G02B 21/365

(57) ABSTRACT

Provided is a microscope including: a detection optical system detecting fluorescence produced in a specimen to acquire fluorescence images; an illumination device causing planar excitation light to be incident on the specimen from different directions along a plurality of incident planes that are parallel to each other with a prescribed spacing therebetween in the direction along the detection optical axis of the system; a drive portion causing relative movement between: the system and the device; and the specimen, in the direction along the detection optical axis, in a state in which each of the incident planes and the focal plane of the system are aligned for each sheet of excitation light; and an image processing unit combining fluorescence images that are acquired when respective sheets of excitation light are incident from the different directions along the same incident plane at different times while the portion causes the relative movement.

### CROSS-REFERENCE TO RELATED APPLICATIONS

This application claims the benefit of Japanese Patent Application No. 2016-124535, the content of which is incorporated herein by reference.

### TECHNICAL FIELD

The present invention relates to a microscope and a microscope-image acquisition method.

### BACKGROUND ART

There are conventionally known microscopes of the sheet-illumination type in which planar excitation light is made incident on a specimen from two opposing directions with the specimen therebetween, along an incident plane intersecting the detection optical axis of a detection optical system that detects fluorescence from the specimen, and fluorescence images that are acquired, for respective sheets of the excitation light from the directions, on the basis of fluorescence produced in the specimen are combined (for example, see PTL 1).

With an epi-illumination system or a transmission illumination system, excitation light focused onto a single spot or a plurality of spots is two-dimensionally scanned, thereby acquiring a two-dimensional image. In contrast to this, with the sheet-illumination type, excitation light is focused in the form of a plane so as to make the thickness thereof in the direction along the detection optical axis substantially equal to the depth of focus of a detection optical system or smaller than the depth of focus, and, because the thickness of the excitation light can be considered as almost constant over a wide range, a wide range within the depth of focus is excited at once, and the other sections are not excited, thereby making it possible to reduce the time required to acquire an image.

### CITATION LIST

### Patent Literature

{PTL 1} United States Patent Application, Publication No. 2011/115895

### SUMMARY OF INVENTION

According to a first aspect, the present invention provides a microscope including: a detection optical system that detects fluorescence produced in a specimen to acquire fluorescence images; a sheet-illumination optical system that can cause planar excitation light to be incident on the specimen from different directions along a plurality of incident planes that are parallel to each other with a prescribed spacing therebetween in a direction along a detection optical axis of the detection optical system; a movement mechanism that causes relative movement between: the detection optical system and the sheet-illumination optical system; and the specimen, in the direction along the detection optical axis in a state in which each of the incident planes and a focal plane of the detection optical system are aligned for each sheet of the excitation light; and an image combining unit that combines fluorescence images that are acquired when respective sheets of the excitation light are incident from the different directions along the same incident plane at different times while the movement mechanism causes the relative movement.

According to a second aspect, the present invention provides a microscope-image acquisition method including: a focusing step of aligning, for each sheet of planar excitation light incident on a specimen from mutually different directions along a plurality of incident planes that are parallel to each other with a prescribed spacing therebetween in a direction along a detection optical axis of a detection optical system, each of the incident planes and a focal plane of the detection optical system; a moving step of causing relative movement between: the focal plane of the detection optical system and the incident plane of the excitation light; and the specimen, in the direction along the detection optical axis, in a state in which the incident plane and the focal plane of the detection optical system are aligned for each sheet of the excitation light, in the focusing step; an incidence step of causing the excitation light to be incident on the specimen from the different directions while causing the relative movement in the moving step; an image acquiring step of acquiring fluorescence images by detecting, with the detection optical system, fluorescence produced in the specimen on which the excitation light has been incident in the incidence step; and a combining step of combining, of the fluorescence images acquired in image acquiring step, the fluorescence images acquired when respective sheets of the excitation light are incident from the different directions along the same incident plane at different times.

### BRIEF DESCRIPTION OF DRAWINGS

FIG. 1 is a view showing, in outline, the configuration of a microscope according to one embodiment of the present invention.

FIG. 2A is a plan view of a state in which excitation light is made incident on a specimen via a left-side light path from an illumination device shown in FIG. 1, viewed in the direction along a detection optical axis.

FIG. 2B is a plan view of a state in which excitation light is made incident on the specimen via a right-side light path from the illumination device shown in FIG. 1, viewed in the direction along the detection optical axis.

FIG. 3 is a flowchart for explaining a microscope-image acquisition method according to the one embodiment of the present invention.

FIG. 4 is a side view showing a state in which excitation light is radiated onto the specimen via the left-side light path while the specimen is moved in the direction along the detection optical axis.

FIG. 5 is a side view showing a state in which the incident plane of planar excitation light from the left-side light path and the incident plane of planar excitation light from the right-side light path are respectively aligned with the focal plane of a detection optical system, with a prescribed spacing between the incident planes in the direction along the detection optical axis.

FIG. 6 is a side view showing a state in which excitation light is radiated onto the specimen via the right-side light path while the specimen is moved in the direction along the detection optical axis.

FIG. 7 is a plan view of example observation areas over a wide range in the specimen and an example observation field, viewed in the direction along the detection optical axis.

### DESCRIPTION OF EMBODIMENT

A microscope and a microscope-image acquisition method according to one embodiment of the present invention will be described below with reference to the drawings.

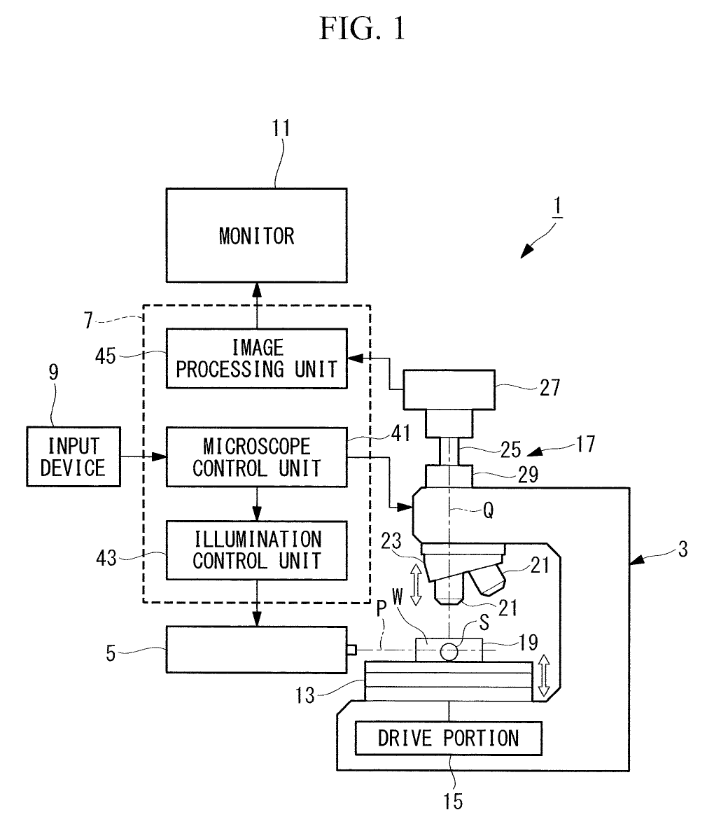

As shown in FIG. 1, a microscope 1 of this embodiment is provided with: a microscope body 3; an illumination device (sheet-illumination optical system) 5 that is connected to the microscope body 3; and a control device 7 that controls the microscope body 3 and the illumination device 5. An input device 9, such as a mouse or a keyboard, through which the user inputs an instruction and a monitor 11 on which an image acquired by the microscope body 3 is displayed are connected to the control device 7.

The microscope body 3 is provided with: a stage 13 on which a specimen S is placed; a drive portion (movement mechanism) 15 that drives the stage 13; and a detection optical system 17 that detects fluorescence produced in the specimen S placed on the stage 13.

The specimen S is accommodated in a vessel 19 placed on the stage 13. The vessel 19 is filled with a fluid W, such as water, and the specimen S is immersed in the fluid W. The vessel 19 is made of a material capable of transmitting excitation light incident from the illumination device 5 and is open in the direction toward the detection optical system 17. It is preferred that the fluid W have substantially the same refractive index as the specimen S, for example.

Under the control of the control device 7, the drive portion 15 can move the stage 13 in the direction along a detection optical axis Q of the detection optical system 17 and in two-dimensional directions perpendicular to this direction.

The detection optical system 17 is provided with: objective lenses 21 each of which is to be disposed at a position vertically above the stage 13 so as to face the stage 13; a revolver 23 that holds the objective lenses 21; an image forming lens 25 that images fluorescence from the specimen S collected by the objective lens 21; and an image acquisition device 27, such as a CCD, that captures the fluorescence imaged by the image forming lens 25 to acquire a fluorescence image. In the figure, reference sign 29 denotes a filter wheel provided with a barrier filter that removes excitation light contained in the fluorescence.

The revolver 23 holds the plurality of objective lenses 21 in a manner allowing the objective lenses 21 to be selectively disposed on the detection optical axis Q. Furthermore, under the control of the control device 7, the revolver 23 can move the objective lens 21 disposed on the detection optical axis Q in the direction along the detection optical axis Q.

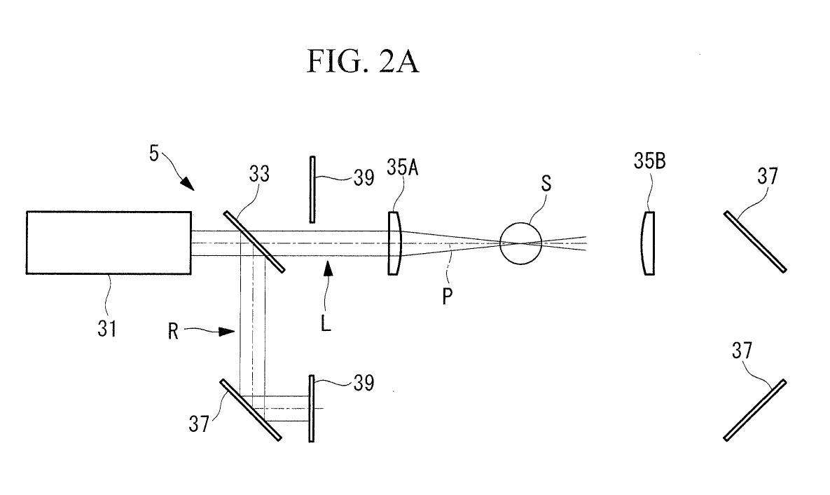

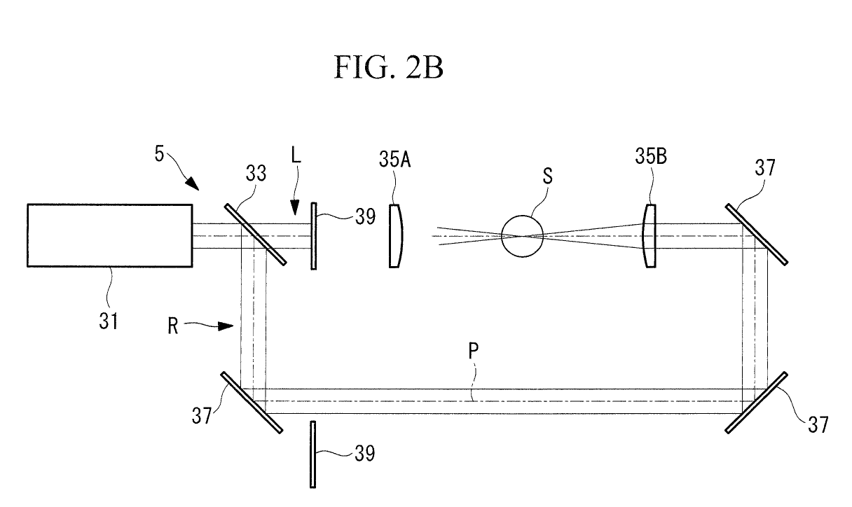

As shown in FIGS. 2A and 2B, the illumination device 5 is provided with: an excitation light source 31 that emits excitation light formed of substantially parallel light, along an illumination optical axis P; a half mirror 33 that splits the excitation light emitted from the excitation light source 31 into two light paths; two cylindrical lenses 35A and 35B that cause the excitation light passing via the two light paths split by the half mirror 33 to be incident on the specimen S from two opposing directions with the specimen S therebetween. In the figure, reference sign 37 denotes mirrors that form the light path, and reference sign 39 denotes shutters that are provided in the two light paths, respectively.

The cylindrical lenses 35A and 35B have powers in one direction perpendicular to the illumination optical axis P and focus the excitation light, which is formed of substantially parallel light, into planar light having a predetermined width dimension that is the same as the beam diameter dimension of the excitation light. Furthermore, the cylindrical lenses 35A and 35B cause the planar excitation light to be incident on the specimen S via the vessel 19 from the respective different directions along a plurality of incident planes that are parallel to each other with a prescribed spacing therebetween in the direction along the detection optical axis Q.

The control device 7 is provided with a PC (personal computer, not shown) and a control board (not shown) that performs input and output of signals between the PC and various electrical components in the microscope body 3 and the illumination device 5.

The PC is provided with a memory (not shown) that stores various programs and an arithmetic processing unit (not shown) that reads each program stored in the memory and executes the program on the basis of a user instruction input through the input device 9.

The memory in the PC stores, for example, an image processing program, a microscope control program, and an illumination control program. Furthermore, it is possible to store, in the memory, a shift in the direction along the detection optical axis Q that occurs between the respective incident planes in the two light paths of the illumination device 5, the shift being measured by the user in advance.

The arithmetic processing unit of the PC has: a function as a microscope control unit that controls the microscope body 3 through the execution of the microscope control program; a function as an illumination control unit that controls the illumination device 5 through the execution of the illumination control program; and a function as an image processing unit that processes a fluorescence image through the execution of the image processing program. Hereinafter, as shown in FIG. 1, the components of the arithmetic processing unit of the PC are referred to as a microscope control unit 41, an illumination control unit 43, and an image processing unit (image combining unit) 45.

Through the execution of the microscope control program, the microscope control unit 41 actuates the revolver 23 to replace or move the objective lens 21 or actuates the filter wheel 29 to replace the filter. Furthermore, through the execution of the microscope control program, the microscope control unit 41 moves the stage 13 two-dimensionally in directions perpendicular to the detection optical axis Q or moves the stage 13 in the direction along the detection optical axis Q in a continuous manner at a constant speed or in a stepwise manner at a predetermined pitch. Furthermore, through the execution of the microscope control program, the microscope control unit 41 causes the image acquisition device 27 to acquire fluorescence images at regular intervals.

Through the execution of the illumination control program, the illumination control unit 43 selectively opens and closes the shutters 39. Specifically, the illumination control unit 43 selectively opens and closes the shutters 39, thereby making it possible to switch between the light path in which excitation light is made incident on the specimen S via the cylindrical lens 35A from one direction (the left side of the specimen S with respect to the plane of FIG. 2A) (hereinafter, referred to as left-side light path L), as shown in FIG. 2A, and the light path in which excitation light is made incident on the specimen S via the cylindrical lens 35B from the other direction (the right side of the specimen S with respect to the plane of FIG. 2B) (hereinafter, referred to as right-side light path R), as shown in FIG. 2B.

The image processing unit 45 has a FIFO image buffer that can temporarily store a fluorescence image sent from the image acquisition device 27. The image processing unit 45 processes the fluorescence image sent from the image acquisition device 27 and displays the processed fluorescence image on the monitor 11. Furthermore, through the execution of the image processing program, the image processing unit 45 combines, among fluorescence images stored in the FIFO image buffer, fluorescence images acquired by the image acquisition device 27 when the respective sheets of excitation light are incident from the left-side light path L and from the right-side light path R along the same incident plane at different times.

For example, the image processing unit 45 may acquire fluorescence images of the same observation area when the excitation light is radiated onto the specimen S from the left-side light path L and when the excitation light is radiated onto the specimen S from the right-side light path R, and may combine the fluorescence images of the same range to generate a single combined image. Furthermore, for example, the image processing unit 45 may acquire fluorescence images of the same observation area when the excitation light is radiated onto the specimen S from the left-side light path L and when the excitation light is radiated onto the specimen S from the right-side light path R, then may cut out, for each of the light paths L and R, an incident-side half area in the direction along the illumination optical axis P, and may put them together to generate a single combined image.

Next, the microscope-image acquisition method of this embodiment will be described.

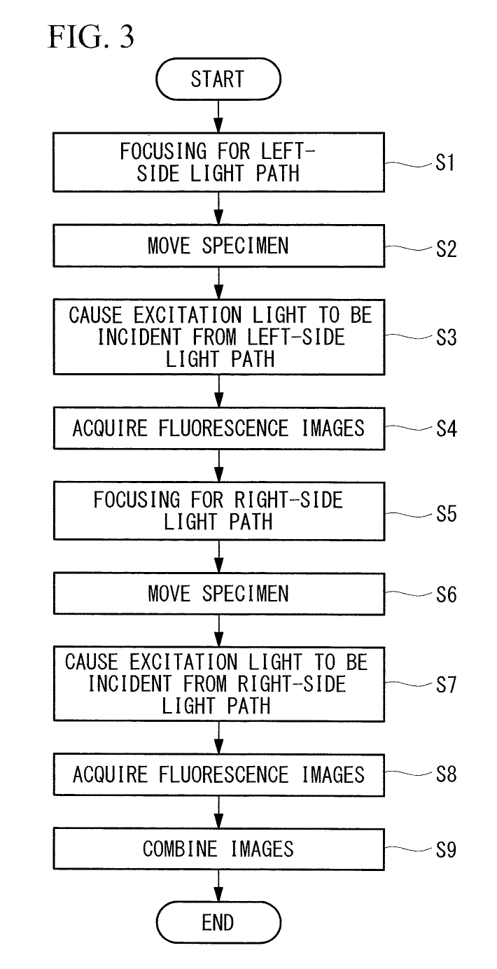

As shown in a flowchart of FIG. 3, the microscope-image acquisition method of this embodiment includes: focusing steps S1 and S5 of aligning the incident plane with the focal plane of the detection optical system 17, for each sheet of planar excitation light incident on the specimen S from mutually different directions along a plurality of incident planes that are parallel to each other with a prescribed spacing therebetween in the direction along the detection optical axis Q of the detection optical system 17; moving steps S2 and S6 of causing relative movement between: the focal plane of the detection optical system 17 and the incident plane of the excitation light; and the specimen S, in the direction along the detection optical axis Q, in the state in which the incident plane and the focal plane of the detection optical system 17 are aligned for each sheet of excitation light in the focusing steps S1 and S5; incidence steps S3 and S7 of causing each sheet of excitation light to be incident on the specimen S from different directions while causing the relative movement in the moving steps S2 and S6; image acquiring steps S4 and S8 of detecting, by means of the detection optical system 17, fluorescence produced in the specimen S by causing the excitation light to be incident thereon in the incidence steps S3 and S7, thus acquiring fluorescence images; and a combining step S9 of combining, of the fluorescence images acquired in the image acquiring steps S4 and S8, the fluorescence images that are acquired when respective sheets of excitation light are incident from the different directions along the same incident plane at different times.

In the combining step S9, combining is applied to fluorescence images that are determined to have been acquired on the same incident plane on the basis of a shift (the distance of the prescribed spacing) that occurs between the incident planes in the two light paths L and R of the illumination device 5 and a movement amount of the specimen S in the direction along the detection optical axis Q moved by the drive portion 15.

The operation of the thus-configured microscope 1 and microscope-image acquisition method will be described with reference to the flowchart of FIG. 3.

In order to observe the specimen S by using the microscope 1 and the microscope-image acquisition method of this embodiment, first, the user measures, in advance, a shift between the incident planes of the excitation light in the left-side light path L and the right-side light path R of the illumination device 5 and stores the shift in the memory of the control device 7 through the input device 9.

Next, the user selectively opens and closes the shutters 39 of the illumination device 5 by means of the illumination control unit 43, to open the left-side light path L and to close the right-side light path R, for example, as shown in FIG. 2A. Then, excitation light is produced in the excitation light source 31.

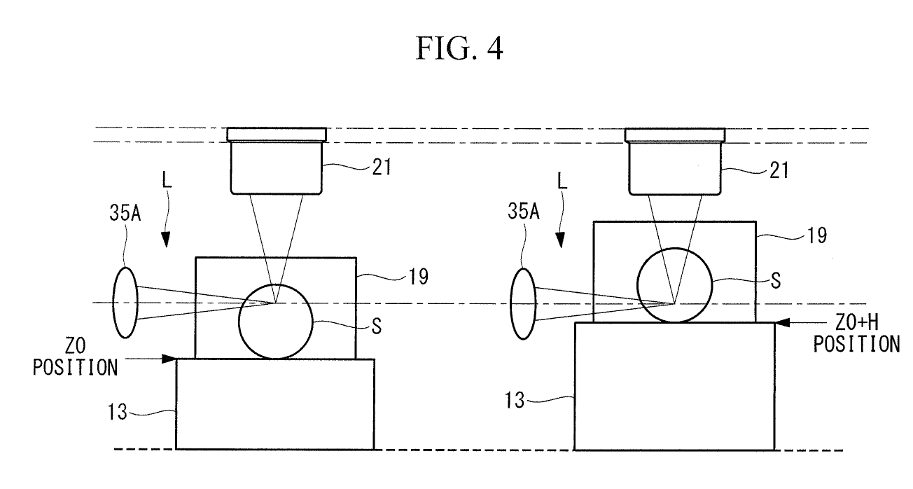

Next, the microscope control unit 41 actuates the revolver 23 to move the objective lens 21 in the direction along the detection optical axis Q and to align the focal plane of the detection optical system 17 with the incident plane of the left-side light path L, as shown in FIG. 4 (the focusing step S1).

Next, in the state in which the incident plane of the left-side light path L and the focal plane of the detection optical system 17 are aligned by means of the microscope control unit 41, the microscope control unit 41 actuates the drive portion 15 to move up the stage 13 from a Z0 position toward a Z0+H position along the detection optical axis Q (the moving step S2).

As shown in FIG. 2A, excitation light emitted from the excitation light source 31 and transmitted through the half mirror 33 is focused in the form of a plane by the cylindrical lens 35A and is incident on the specimen S from the left-side light path L along the incident plane, the specimen S being moved together with the stage 13 in the direction along the detection optical axis Q (the incidence step S3). When the planar excitation light is incident on the specimen S, a fluorescent substance in the specimen S is excited along the incident plane of the excitation light, thus producing fluorescence.

Of the fluorescence produced in the specimen S when the excitation light is incident on the specimen S from the left-side light path L, the fluorescence radiated in the direction along the detection optical axis Q is collected by the objective lens 21, passes through the barrier filter in the filter wheel 29, is imaged by the image forming lens 25, and is captured by the image acquisition device 27. Then, the microscope control unit 41 controls the image acquisition device 27 to acquire fluorescence images at certain time intervals (the image acquiring step S4). Accordingly, through radiation of the excitation light from the left-side light path L, a plurality of fluorescence images, i.e., stack images, are acquired at regular intervals within the range from the Z0 position to the Z0+H position of the stage 13.

The plurality of fluorescence images of the specimen S acquired through radiation of the excitation light from the left-side light path L are referred to as Left[0], Left[1], . . . , and Left[m], for example, in time-series order from the Z0 position side. [0], [1], . . . , and [m] indicate array numbers. These fluorescence images are stored in the FIFO image buffer of the image processing unit 45.

Next, the user switches opening and closing of the shutters 39 of the illumination device 5 by means of the illumination control unit 43, thus closing the left-side light path L and opening the right-side light path R, for example, as shown in FIG. 2B.

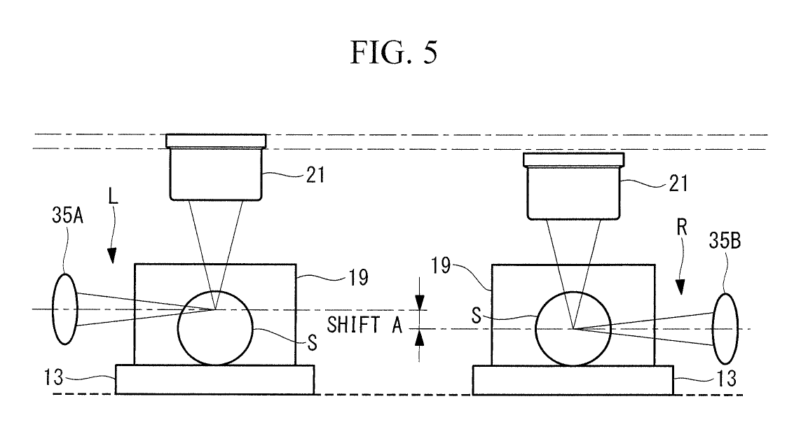

Next, the microscope control unit 41 actuates the revolver 23 to move the objective lens 21 in the direction along the detection optical axis Q by a shift A, to align the focal plane of the detection optical system 17 with the incident plane of the right-side light path R, as shown in FIG. 5 (the focusing step S5). In the example shown in FIG. 5, the incident plane of the right-side light path R is shifted downward in the vertical direction by the shift A from the incident plane of the left-side light path L.

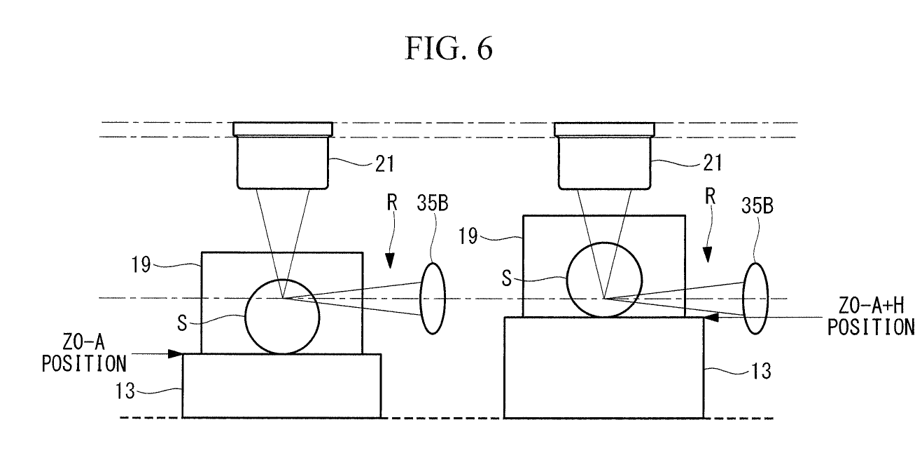

Next, in the state in which the incident plane of the right-side light path R and the focal plane of the detection optical system 17 are aligned, the user actuates, by means of the microscope control unit 41, the drive portion 15 to move the stage 13 up along the detection optical axis Q from a Z0-A position toward a Z0-A+H position, as shown in FIG. 6 (the moving step S6).

As shown in FIG. 2B, excitation light emitted from the excitation light source 31 and reflected by the half mirror 33 and the mirrors 37 is focused by the cylindrical lens 35B in the form of a plane, and is incident on the specimen S from the right-side light path R along the incident plane, the specimen S being moved together with the stage 13 in the direction along the detection optical axis Q (the incidence step S7). When the planar excitation light is incident on the specimen S, the fluorescent substance in the specimen S is excited along the incident plane of the excitation light, thus producing fluorescence.

The fluorescence produced in the specimen S in the direction along the detection optical axis Q when the excitation light from the right-side light path R is incident on the specimen S is collected by the objective lens 21, passes through the filter wheel 29 and the image forming lens 25, and is captured by the image acquisition device 27, as in the fluorescence produced by the excitation light from the left-side light path L. Then, the microscope control unit 41 controls the image acquisition device 27 to acquire fluorescence images at certain time intervals (the image acquiring step S8). Accordingly, through radiation of the excitation light from the right-side light path R, a plurality of fluorescence images, i.e., Z stack images, are acquired at regular intervals within the range from the Z0-A position to the Z0-A+H position of the stage 13.

The fluorescence images of the specimen S acquired through radiation of the excitation light from the right-side light path R are referred to as Right[0], Right[1], . . . , and Right[m], for example, in time-series order from the Z0-A position side. These fluorescence images are also stored in the FIFO image buffer of the image processing unit 45.

Next, of the plurality of fluorescence images stored in the FIFO image buffer, the fluorescence images having the same array number, for example, Left[0] and Right[0], Left[1] and Right[1], . . . , and Left[m] and Right[m], are respectively combined by the image processing unit 45 (the combining step S9). The combined fluorescence images of the specimen S are sent to the monitor 11 and are displayed thereon.

As described above, according to the microscope 1 and the microscope-image acquisition method of this embodiment, the focal plane of the detection optical system 17 is aligned with the incident plane of the planar excitation light, thereby making it possible to detect at once the fluorescence produced in the specimen S within a wide range along the focal plane, by means of the detection optical system 17. Furthermore, by causing the excitation light to be incident on the specimen S from the different directions, the incident depth of the excitation light incident on the specimen S from each of the directions can be reduced, thus suppressing the influence of scattering in the specimen S and making it possible to acquire a clear fluorescence image.

In this case, in the state in which the incident plane and the focal plane of the detection optical system 17 are aligned for each sheet of the excitation light incident on the specimen S from the left-side light path L and the right-side light path R, the specimen S is moved in the direction along the detection optical axis Q, thereby making it possible to acquire, by means of the detection optical system 17, a plurality of fluorescence images including images that are acquired on the same incident plane of the excitation light incident on the specimen S from the left-side light path L and the right-side light path R at different times.

Accordingly, without adjusting the illumination device 5 so as to align the incident planes of the excitation light in the respective incident directions with each other, it is possible to generate clear combined images simply by combining fluorescence images acquired when respective sheets of excitation light are incident from the left-side light path L and the right-side light path R along the same incident plane at different times. Therefore, with the sheet-illumination type, clear combined images can be easily acquired with a simple configuration, without using a complicated and expensive adjustment mechanism for adjusting the illumination device 5 and without requiring complicated adjustment.

In this embodiment, although an example case in which one observation area in the specimen S is observed has been illustrated, for example, it is also possible to observe a plurality of observation areas over a wide range in the specimen S.

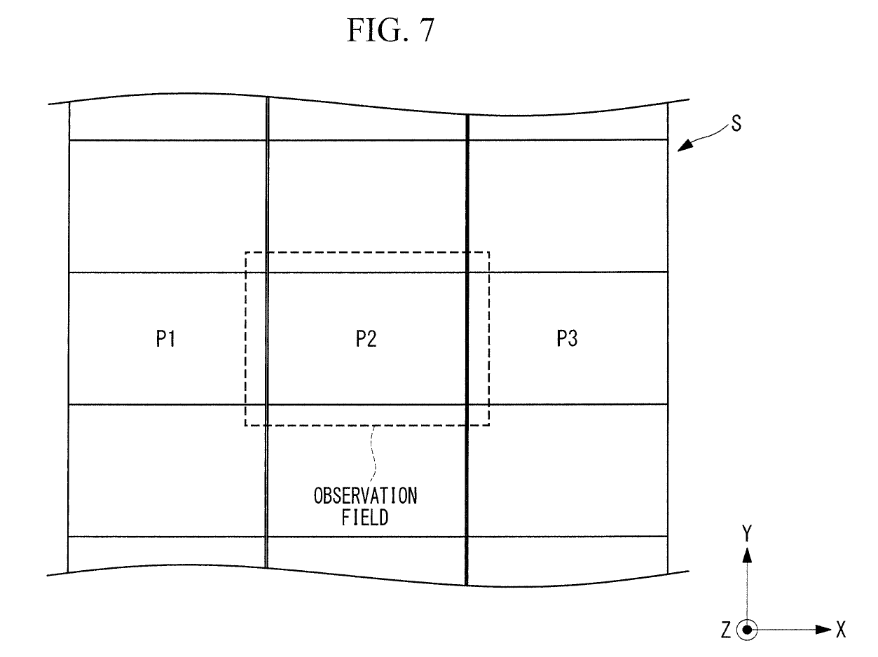

With reference to FIG. 7, a description will be given below of an example case in which three observation areas 21, P2, and P3 in the specimen S, that are adjacent in a direction intersecting the detection optical axis Q, are observed. The direction along the detection optical axis Q is the Z direction, and directions intersecting the detection optical axis Q are X and Y directions.

First, when the observation area P1 in the specimen S is observed, the illumination control unit 43 selectively opens and closes the shutters 39 of the illumination device 5, to open the left-side light path L and to close the right-side light path R, thus radiating excitation light only from the left-side light path L. Then, the microscope control unit 41 moves the stage 13 in the X and Y directions to move the observation area P1 to the inside of the observation field of the microscope 1.

Next, the microscope control unit 41 aligns the focal plane of the detection optical system 17 with the incident plane of the left-side light path L, and causes planar excitation light to be incident on the specimen S via the left-side light path L from the excitation light source 31 while causing the drive portion 15 to move the stage 13 from the Z0 position to the Z0+H position. Then, the image acquisition device 27 captures fluorescence from the specimen S and acquires m stack images (fluorescence images) at certain time intervals. The stack images of the observation area P1 are referred to as P1[0], P1[1], . . . , and P1[m] in time-series order from the Z0 position side. These stack images are stored in the FIFO image buffer of the image processing unit 45.

Next, when the observation area P2 is observed, the illumination control unit 43 selectively opens and closes the shutters 39 of the illumination device 5 to switch between the excitation light from the left-side light path L and the excitation light from the right-side light path R, for radiation. Then, the microscope control unit 41 actuates the drive portion 15 to move the stage 13 in the X and Y directions to move the observation area P2 to the inside of the observation field of the microscope 1.

In the case of the left-side light path L, the microscope control unit 41 actuates the revolver 23 to align the focal plane of the detection optical system 17 with the incident plane of the left-side light path L and causes the planar excitation light to be incident on the specimen S via the left-side light path L from the excitation light source 31 while causing the drive portion 15 to move the stage 13 from the Z0 position to the Z0+H position. Then, the image acquisition device 27 captures fluorescence from the specimen S and acquires m stack images at certain time intervals.

In the case of the right-side light path R, the microscope control unit 41 actuates the revolver 23 to align the focal plane of the detection optical system 17 with the incident plane of the right-side light path R and causes the planar excitation light to be incident on the specimen S via the right-side light path R from the excitation light source 31 while causing the drive portion 15 to move the stage 13 from the Z0-A position to the Z0-A+Z position. Then, the image acquisition device 27 captures fluorescence from the specimen S and acquires m images at regular intervals.

Next, the image processing unit 45 generates m combined images by respectively combining the fluorescence images Left[0], Left[1], . . . , and Left[m] and the fluorescence images Right[0], Right[1], . . . , and Right[m], which are acquired when respective sheets of excitation light are incident from the left-side light path L and the right-side light path R along the same incident plane at different times. The combined images of the observation area P2 are referred to as P2[0], P2[1], . . . , and P2[m] in time-series order from the Z0 position side. These combined images are also stored in the FIFO image buffer of the image processing unit 45.

Next, the observation area P3 in the specimen S is observed, the illumination control unit 43 selectively opens and closes the shutters 39 of the illumination device 5, to close the left-side light path L and to open the right-side light path R, thus radiating excitation light only from the right-side light path R. Then, the microscope control unit 41 moves the stage 13 in the X and Y directions, to move the observation area P3 to the inside of the observation field of the microscope 1.

Next, the microscope control unit 41 aligns the focal plane of the detection optical system 17 with the incident plane of the right-side light path R and causes planar excitation light to be incident on the specimen S via the right-side light path R from the excitation light source 31 while causing the drive portion 15 to move the stage 13 from the Z0-A position to the Z0-A+H position. Then, the image acquisition device 27 captures fluorescence from the specimen S and acquires m stack images at certain time intervals. The stack images of the observation area P3 are referred to as P3[0], P3[1], . . . , and P3[m] in time-series order from the Z0-A position side. These stack images are also stored in the FIFO image buffer of the image processing unit 45.

Next, of the plurality of fluorescence images of the three observation areas P1, P2, and P3, which are stored in the FIFO image buffer, the image processing unit 45 puts together the fluorescence images with the same array number that are acquired when respective sheets of excitation light are incident along the same incident plane at different times, for example, P1[0], P2[0], and P3[0]; P1[1], P2[1], and P3[1]; . . . ; and P1[m], P2[m], and P3[m]. Accordingly, continuous combined images of the observation areas P1, P2, and P3 are generated.

As described above, according to the microscope 1 and the microscope-image acquisition method of this embodiment, even when the plurality of observation areas P1, P2, and P3, which extend over a wide range in the specimen S, are observed, clear combined images can be easily acquired with a simple configuration of the sheet-illumination type, without using a complicated and expensive adjustment mechanism for adjusting the illumination device 5 and without requiring complicated adjustment.

Although the embodiment of the present invention has been described above in detail with reference to the drawings, the specific configuration is not limited to the embodiment, and design changes etc. that do not depart from the scope of the present invention are also encompassed. For example, the present invention is not limited to those applied to the above-described embodiment and modification, can also be applied to the embodiment obtained by appropriately combining the embodiment and the modification, and is not particularly limited. For example, in the above-described embodiment, although excitation light is incident on the specimen S from two directions opposite to each other, it is also possible to cause the excitation light to be incident on the specimen S from three or more directions, for example.

Furthermore, in the above-described embodiment, although the positions of the detection optical system 17 and the illumination device 5 are fixed, and the specimen S is moved, relative movement needs to be caused between: the detection optical system 17 and the illumination device 5; and the specimen S. For example, it is also possible to fix the position of the specimen S and to integrally move the detection optical system 17 and the illumination device 5 in the direction along the detection optical axis Q in the state in which the incident plane of the excitation light and the focal plane of the detection optical system 17 are aligned. Alternatively, it is also possible to move both of: the detection optical system 17 and the illumination device 5; and the specimen S.

The following invention is derived from the above-described embodiment.

According to a first aspect, the present invention provides a microscope including: a detection optical system that detects fluorescence produced in a specimen to acquire fluorescence images; a sheet-illumination optical system that can cause planar excitation light to be incident on the specimen from different directions along a plurality of incident planes that are parallel to each other with a prescribed spacing therebetween in a direction along a detection optical axis of the detection optical system; a movement mechanism that causes relative movement between: the detection optical system and the sheet-illumination optical system; and the specimen, in the direction along the detection optical axis in a state in which each of the incident planes and a focal plane of the detection optical system are aligned for each sheet of the excitation light; and an image combining unit that combines fluorescence images that are acquired when respective sheets of the excitation light are incident from the different directions along the same incident plane at different times while the movement mechanism causes the relative movement.

According to this aspect, because the sheet-illumination optical system causes planar excitation light to be incident on the specimen along a plurality of incident planes that are parallel to each other with a prescribed spacing therebetween in the direction along the detection optical axis of the detection optical system, fluorescence produced in a wide range along the focal plane can be detected at once by the detection optical system, by aligning the focal plane of the detection optical system with each of the incident planes. Furthermore, by causing the excitation light to be incident on the specimen from the different directions, the incident depth of the excitation light incident on the specimen from each of the directions can be reduced, thus suppressing the influence of scattering in the specimen and making it possible to acquire a clear fluorescence image.

In this case, the movement mechanism causes relative movement between: the detection optical system and the sheet-illumination optical system; and the specimen, in the direction along the detection optical axis, in a state in which the incident plane and the focal plane of the detection optical system are aligned for each sheet of excitation light incident on the specimen from the different directions, thereby making it possible to acquire, with the detection optical system, a plurality of fluorescence images including images that are acquired on the same incident plane of the excitation light incident on the specimen from the different directions at different times.

Accordingly, without adjusting the sheet-illumination optical system so as to align the incident planes of the excitation light in the respective incident directions with each other, it is possible to generate a clear combined image simply by combining, in the image combining unit, fluorescence images acquired when respective sheets of excitation light are incident from the different directions along the same incident plane at different times. Therefore, clear combined images can be acquired with a simple configuration of the sheet-illumination type, without using a complicated and expensive adjustment mechanism for adjusting the sheet-illumination optical system.

In the above-described aspect, the movement mechanism may fix the positions of the detection optical system and the sheet-illumination optical system and may move the specimen in the direction along the detection optical axis.

With this configuration, it is possible to acquire a plurality of stack images of the specimen at different positions in the direction along the detection optical axis, with a simple configuration in which the specimen is only moved in the direction along the detection optical axis of the detection optical system.

In the above-described aspect, the movement mechanism may fix the position of the specimen and may integrally move the detection optical system and the sheet-illumination optical system in the direction along the detection optical axis.

With this configuration, it is possible to acquire a plurality of stack images of the specimen at different positions in the direction along the detection optical axis, without moving the specimen. This is effective in a case in which the specimen cannot be moved.

According to a second aspect, the present invention provides a microscope-image acquisition method including: a focusing step of aligning, for each sheet of planar excitation light incident on a specimen from mutually different directions along a plurality of incident planes that are parallel to each other with a prescribed spacing therebetween in a direction along a detection optical axis of a detection optical system, each of the incident planes and a focal plane of the detection optical system; a moving step of causing relative movement between: the focal plane of the detection optical system and the incident plane of the excitation light; and the specimen, in the direction along the detection optical axis, in a state in which the incident plane and the focal plane of the detection optical system are aligned for each sheet of the excitation light, in the focusing step; an incidence step of causing the excitation light to be incident on the specimen from the different directions while causing the relative movement in the moving step; an image acquiring step of acquiring fluorescence images by detecting, with the detection optical system, fluorescence produced in the specimen on which the excitation light has been incident in the incidence step; and a combining step of combining, of the fluorescence images acquired in image acquiring step, the fluorescence images acquired when respective sheets of the excitation light are incident from the different directions along the same incident plane at different times.

According to this aspect, in the focusing step, each of the incident planes and the focal plane of the detection optical system are aligned for each sheet of excitation light incident on the specimen from the different directions; in the incidence step, planar excitation light is incident on the specimen along the plurality of incident planes parallel to each other with a prescribed spacing therebetween in the direction along the detection optical axis of the detection optical system; and thus, in the image acquiring step, fluorescence produced in a wide range along the focal plane can be detected at once. Furthermore, by causing the excitation light to be incident on the specimen from the mutually different directions, the incident depth of the excitation light incident on the specimen from each of the directions can be reduced, thus suppressing the influence of scattering in the specimen and making it possible to acquire a clear fluorescence image.

In this case, in the moving step, in a state in which the incident plane and the focal plane of the detection optical system are aligned for each sheet of excitation light, relative movement is caused between: the focal plane of the detection optical system and the incident plane of the excitation light; and the specimen, in the direction along the optical axis direction; in the meanwhile, in the incidence step, the excitation light is incident on the specimen from the respective incident directions; and thus, in the image acquiring step, it is possible to acquire a plurality of fluorescence images including images that are acquired on the same incident plane of the excitation light incident on the specimen from the different directions at different times.

Accordingly, without adjusting the optical system so as to align the incident planes of the excitation light in the respective incident directions with each other, it is possible to generate, in the combining step, clear combined images simply by combining fluorescence images acquired when respective sheets of excitation light are incident from the different directions along the same incident plane at different times. Therefore, clear fluorescence images can be easily acquired with the sheet-illumination type, without requiring complicated and cumbersome adjustment.

In the above-described aspect, in the combining step, the fluorescence images that are determined to have been acquired on the same incident plane on the basis of the distance of the prescribed spacing and a movement amount of the relative movement may be combined.

With this configuration, fluorescence images that are acquired on the same incident plane of sheets of excitation light in the respective incident directions can be easily identified and combined simply by measuring, in advance, the distance of the prescribed spacing.

In the above-described aspect, in the moving step, the focal plane of the detection optical system and the incident plane of the excitation light may be fixed, and the specimen may be moved in the direction along the detection optical axis.

With this configuration, through a simple operation in which the specimen is only moved in the direction along the detection optical axis of the detection optical system, it is possible to acquire a plurality of stack images of the specimen at different positions in the direction along the detection optical axis.

In the above-described aspect, in the moving step, the position of the specimen may be fixed, and the focal plane of the detection optical system and the incident plane of the excitation light may be integrally moved in the direction along the detection optical axis.

With this configuration, it is possible to acquire a plurality of stack images of the specimen at different positions in the direction along the detection optical axis, without moving the specimen.

### REFERENCE SIGNS LIST

1 microscope
5 illumination device (sheet-illumination optical system)
15 drive portion
17 detection optical system
45 image processing unit (image combining unit)
S1, S5 focusing step
S2, S6 moving step
S3, S7 incidence step
S4, S8 image acquiring step
S9 combining step
S specimen

1. A microscope comprising:
a detection optical system that detects fluorescence produced in a specimen to acquire fluorescence images;
a sheet-illumination optical system that can cause planar excitation light to be incident on the specimen from different directions along a plurality of incident planes that are parallel to each other with a prescribed spacing therebetween in a direction along a detection optical axis of the detection optical system;
a movement mechanism that causes relative movement between: the detection optical system and the sheet-illumination optical system; and the specimen, in the direction along the detection optical axis in a state in which each of the incident planes and a focal plane of the detection optical system are aligned for each sheet of the excitation light; and
an image combining unit that combines fluorescence images that are acquired when respective sheets of the excitation light are incident from the different directions along the same incident plane at different times while the movement mechanism causes the relative movement.

2. A microscope according to claim 1, wherein the movement mechanism fixes the positions of the detection optical system and the sheet-illumination optical system and moves the specimen in the direction along the detection optical axis.

3. A microscope according to claim 1, wherein the movement mechanism fixes the position of the specimen and integrally moves the detection optical system and the sheet-illumination optical system in the direction along the detection optical axis.

4. A microscope-image acquisition method comprising:
aligning, for each sheet of planar excitation light incident on a specimen from mutually different directions along a plurality of incident planes that are parallel to each other with a prescribed spacing therebetween in a direction along a detection optical axis of a detection optical system, each of the incident planes and a focal plane of the detection optical system;
causing relative movement between: the focal plane of the detection optical system and the incident plane of the excitation light; and the specimen, in the direction along the detection optical axis, in a state in which the incident plane and the focal plane of the detection optical system are aligned for each sheet of the excitation light;
causing the excitation light to be incident on the specimen from the different directions while causing the relative movement;
acquiring fluorescence images by detecting, with the detection optical system, fluorescence produced in the specimen on which the excitation light has been incident; and
combining, of the acquired fluorescence images, the fluorescence images acquired when respective sheets of the excitation light are incident from the different directions along the same incident plane at different times.

5. A microscope-image acquisition method according to claim 4, wherein, in the combining, the fluorescence images that are determined to have been acquired on the same incident plane on the basis of the distance of the prescribed spacing and a movement amount of the relative movement are combined.

6. A microscope-image acquisition method according to claim 4, wherein, in the relative movement, the focal plane of the detection optical system and the incident plane of the excitation light are fixed, and the specimen is moved in the direction along the detection optical axis.

7. A microscope-image acquisition method according to claim 4, wherein, in the relative movement, the position of the specimen is fixed, and the focal plane of the detection optical system and the incident plane of the excitation light are integrally moved in the direction along the detection optical axis.
